(19) United States
(12) Patent Application Publication
(10) Pub. No.: US 2021/0344206 A1
(43) Pub. Date: Nov. 4, 2021

(54) BAG WITH POCKET AND WIRELESS BATTERY CHARGER FOR MOBILE PHONES

(71) Applicant: EVOBAG S.R.L., Roma (IT)

(72) Inventors: Andrea DANTI, Roma (IT); Marco DI TORO, Roma (IT)

(73) Assignee: EVOBAG S.R.L., Roma (IT)

(21) Appl. No.: 17/286,779

(22) PCT Filed: Oct. 18, 2018
(86) PCT No.: PCT/IT2018/000134

§ 371 Date: Apr. 19, 2021

(51) Int. Cl. H02J 7/00; H02J 7/34; H02J 50/10; H02J 50/90; H02J 50/40; A45C 3/06; A45C 1/06; A45C 15/00; A45F 3/04; A45C 13/02

(52) U.S. Cl. CPC H02J 7/0044; H02J 7/342; H02J 50/10; H02J 50/90; H02J 7/0047; H02J 50/80; A45C 3/06; A45C 1/06; A45C 15/00; A45F 3/04; A45C 13/02; H02J 50/40

(57) ABSTRACT

A wireless charger system for mobile electronic devices comprising, in combination, a pocket suitable for receiving a mobile electronic device inside it; such pocket (2B) being provided with a first transmitter for direct charging of a mobile electronic device; a power supply battery; a charging powerbank (IB) comprising a receiver for its own wireless charging, —an electrical wired connection between the pocket and the powerbank; a control unit in functional communication with the power supply battery and with said first wireless charging means or powerbank constituting means; a charging dock (3B) of the system itself, comprising a second transmitter for charging the powerbank, and a connection to an external electric power source; sensors for the presence of a mobile electronic device in the pocket, in communication with the control unit; light-emitting diodes in connection with the powerbank; as well as a bag (B), garment or accessory of clothing equipped with the system.

The present invention relates to the field of powerbanks for charging mobile phones or other mobile electronic devices.

Although it is already possible to charge in a wireless manner i.e. via wireless systems devices such as smartphones and smartwatches, the current charging devices (e.g. those with inductive charge) are used only as plain power supplies: the user is conditioned by having to remember to charge their devices, just like when charging one's smartphone with a traditional non-wireless power supply.

Also, when the user moves elsewhere, leaves the house or the office, they naturally perform automatic daily gestures: one of these is to put away one's smartphone in the pocket of a suit, a bag, a backpack. From a research certified by the Piepoli institute, 84% of users mostly leave their bag/backpack always in the same place.

In consideration of the foregoing, the present invention aims to provide a charging system for mobile phones and other mobile electronic devices, which can be used within the scope of normal daily gestures.

Another object of the present invention is to provide such a system that it is completely wireless, i.e. in which both the method used to charge mobile devices connected to it, and the manner in which the system is in turn charged, are both wireless.

Another object of the present invention is to provide a charging system for mobile electronic devices that can be used in a one-handed operation mode, i.e. so as to be charged and in turn charge mobile devices using one hand.

These objects are achieved by the present invention with a charging system for mobile electronic devices, including mobile phones, completely wireless, comprising a smart pocket, a battery, a control unit, a wireless receiver and a charging dock connected to an external power source.

The smart pocket connected in the invention system can charge:
any device that supports native wireless charging
any device that does not support native wireless charging: in this case, the pocket is supplied with an accessory to be applied to the device, making it chargeable in a wireless manner.

With the invention system, the devices can be charged simply by placing them inside the smart pocket: the pocket is actually designed to keep the devices inside it in an appropriate position so that charging is always optimal, considering that the pocket-smartphone coupling is millimetric in order to guarantee charging area tolerance.

If the device to be charged should have the wireless charging area in a non-standard position (in most smartphones it is positioned in the middle), the pocket can be provided with suitable supports so that the device can still become aligned in the correct position for charging.

The pocket can be designed according to the size of the products that have to contain it, such as bags, backpacks, jackets: the electronic hardware that allows for charging is in fact smaller/equal in size to the devices to be charged and does not affect the design of the pocket.

The pocket can be made of any material: leather, eco-friendly leather, cotton, wool, as well as synthetic materials, plastics and fibres of any kind, to be applied to any fashion item and high-tech product.

It is contemplated that charging can take place through an integrated USB port, with the advantage of also charging devices with larger footprints than the pocket.

Currently the following products are available on the market:
Piquadro: backpack that has a removable powerbank in a pocket, capable of contactlessly charging a smartphone that is located in the adjacent pocket. The powerbank can be charged in turn wirelessly only by pulling it out of the backpack; otherwise, if located inside the backpack, it is only charged in a wired manner;
Everpurse: a women's bag that can charge one smartphone model only, placing same inside a slot, shaped exactly for that model of smartphone. The charging of the smartphone is in fact done via a connector inside the slot and there is no possibility of charging a different smartphone. The bag charging is exclusively on a proprietary wireless basis.
Leoht: women's bag that can charge devices exclusively through USB ports. Only the charging of the bag battery is wireless.

None of the aforementioned products offers the same features as the invention system.

The pocket charging system is preceptive with respect to those currently known. The invention system, that is, applies to the complete mobile device charging cycle, starting from the external power source, taken off an electrical outlet, up to the batteries of the mobile devices, the whole through user's routine movements.

The invention system can not be implemented with standard hardware components currently available commercially: in fact, in order for the system to work properly in full wireless mode, the components must be changed with suitable precautions.

This change, in terms of hardware and operation, makes them unique compared to those currently available commercially and at the same time, complementary, because if considered independently, they would have no reason to be.

Currently, the marketed powerbanks that integrate the wireless charging mode do not allow the use mode defined by the invention system because:

1. once they have run flat or are switched off, they must be powered back on by physically pressing a button, and therefore, they could not be integrated and made inaccessible inside products.

2. the wireless charge receiver and transmitter components are all or partially integrated into the body of the powerbank: this prevents the invention functionality, as spatial separation of the powerbank charging site with respect to that of the devices is necessary

3. the LEDs are integrated and if the powerbank is inaccessible there is no possibility of viewing their status. The only solution is therefore to have LEDs that indicate the state of charge of the powerbank, externally to the integrating product, but still controlled by the powerbank.

The electronic hardware of the pocket can be with an integrated battery, or take power off another battery located in another compartment.

In both cases the invention system is in turn charged wirelessly, using a charging dock of the present invention, or commercially available wireless charging devices.

The use of a charging dock of the present invention has two advantages:
pocket charging is of the fast charge type
the invention charging dock features a self-centring system that allows for positioning by the user on the invention bag or backpack (which integrate the pocket) without paying too much attention to the required gesture: the half-spherical shape of the four alignment areas and the dimensions of the invention charging dock, together with the supports installed on the bag or the backpack of the invention system, have been designed to automatically align the wireless receiver and transmitter, making the most of the force of gravity; optionally a further system could be implemented to guarantee perfect self-centring, for example with magnets.

The present invention will be fully understood on the basis of the following description of embodiments thereof, provided solely by way of non-limiting example, of the original invention teaching, with reference to the attached figures, wherein:

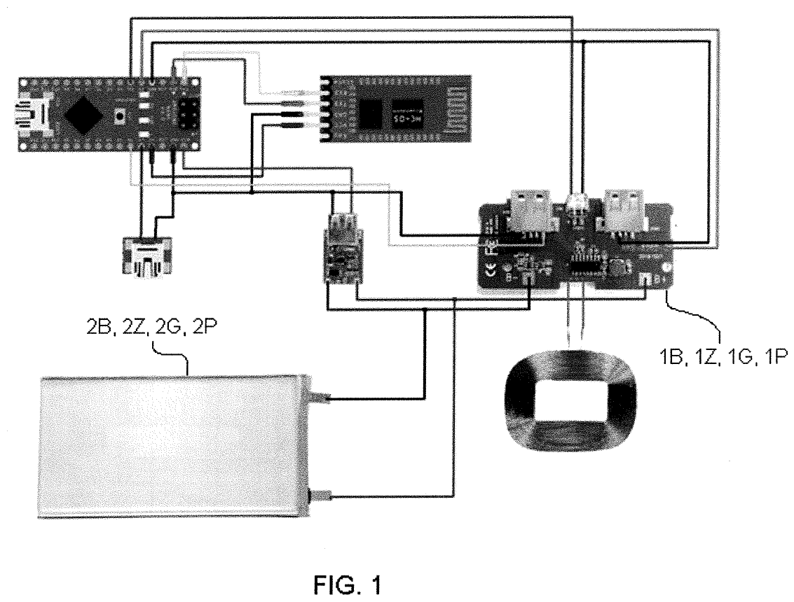

FIG. 1 is a wiring diagram of a charging system according to the present invention;

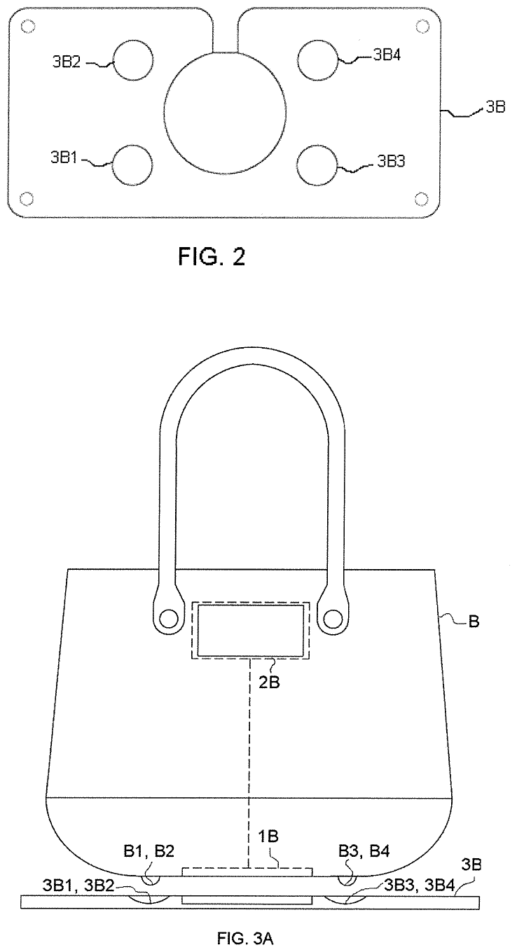

FIG. 2 is a view from above of a charging dock according to the present invention;

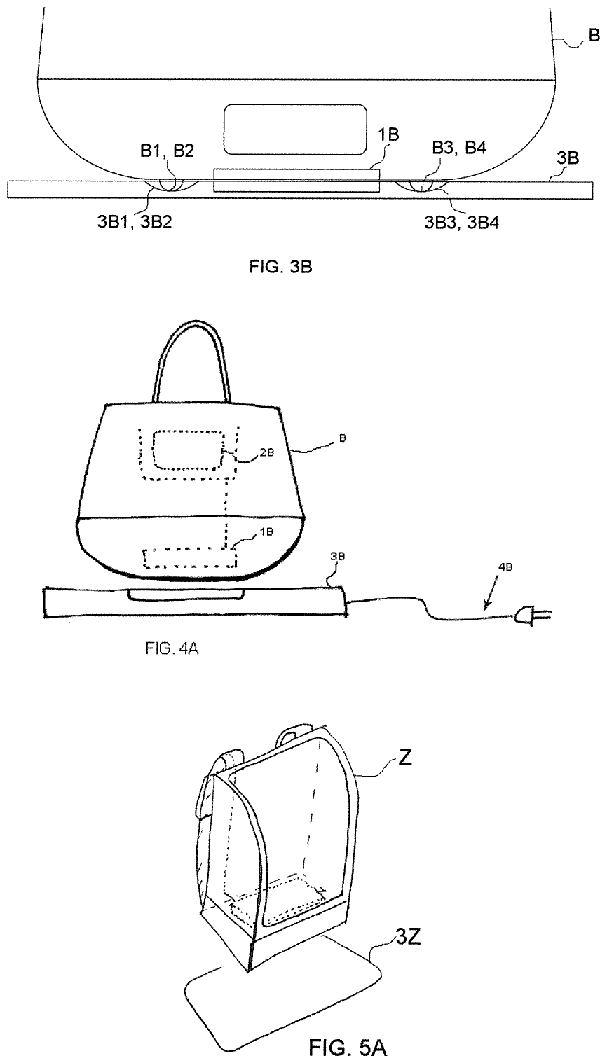

FIGS. 3A and 3B illustrate an invention bag in the placement phase and in a placed state on the invention charging dock through recesses and pins;

FIG. 4A illustrates a bag provided with the invention pocket when resting on the charging dock;

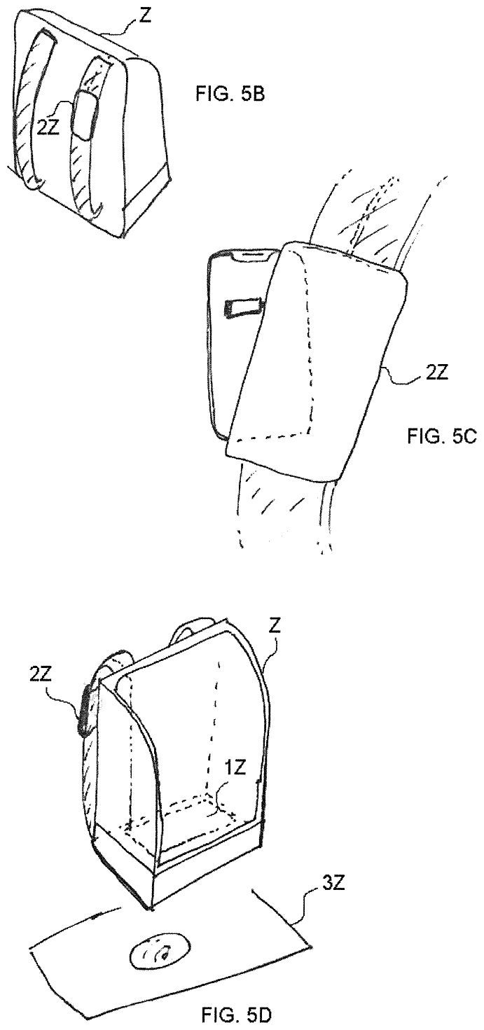

FIGS. 5A, 5B, 5C, 5D illustrate an invention backpack;

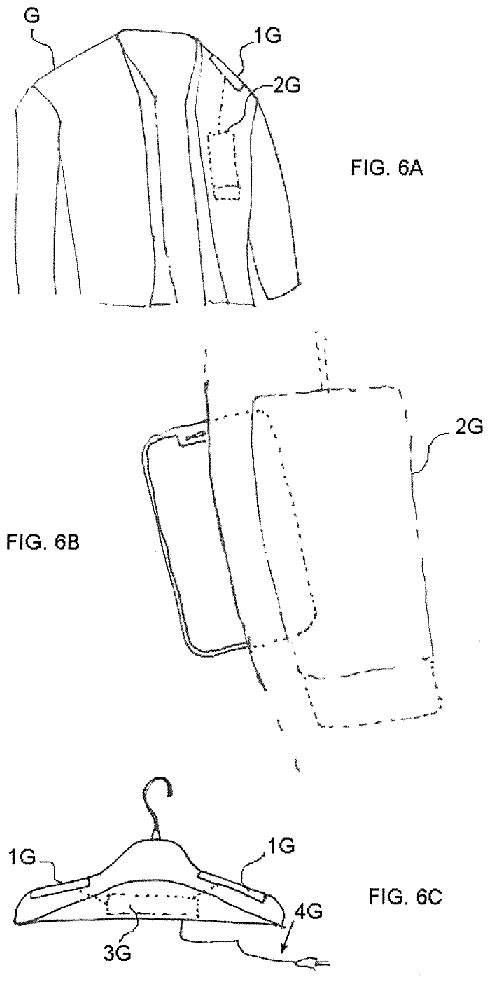

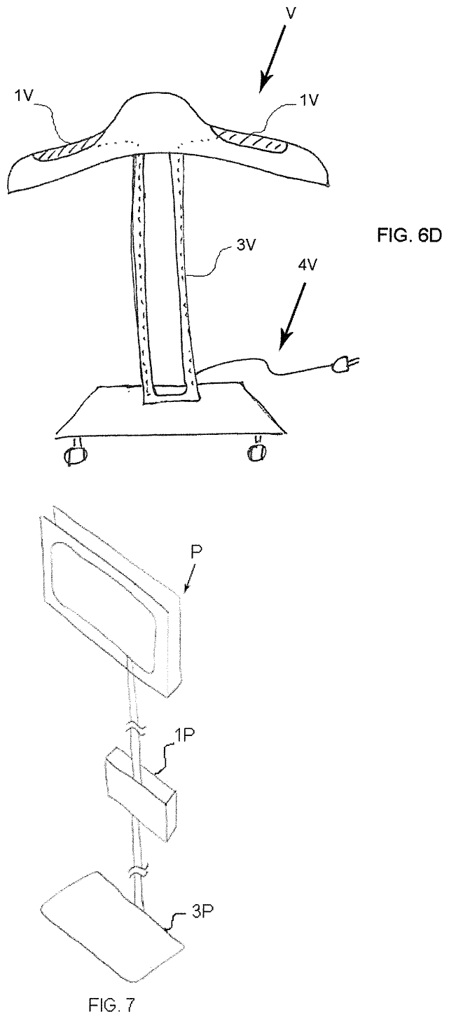

FIGS. 6A and 6B illustrate a jacket equipped with an invention pocket;

FIGS. 6C and 6D illustrate a hanger and a valet stand according to the present invention, respectively;

FIG. 7 illustrates a wallet according to the present invention.

As illustrated in the FIGURES, the invention system includes:

a powerbank 1B, 1Z, 1G, 1P which comprises at least one wireless input port, i.e. an integrated receiver ( ) which allows for charging; this charging can be done in a fast charge mode, as well as in a standard manner. Additionally, the powerbank has at least three output ports with these characteristics:

1. a first USB output port ( ) that powers and controls the smart pocket and always provides adequate power supply for the correct functioning of the pocket, that is, supplying the amperage and voltage required by the wireless transmitter appliance integrated in the pocket, both in presence and in the absence of load. An invention powerbank is preceptively provided with sensors, e.g. magnetic sensors, functionally connected to automatically condition the standby system of the powerbank itself, otherwise there would be two problems: (a) the wireless transmitter would not be activated after being turned off due to no load; (b) the powerbank would run flat too quickly even in the absence of a load;

2. a second USB output port that powers and controls an LED of a smart pocket connection status logo, allowing to understand intuitively, even remotely, if the powerbank is charging, without the use of hands and without having to inspect the inside of the product that integrates it, e.g. a bag B.

Unlike standard products that house the powerbank inside them, however, requiring the user to have to use one's hands to reach the powerbank or even remove it, with the invention powerbank just a quick look from the outside of the bag is sufficient, thus fulfilling the purpose of the invention here above.

An alternative embodiment of the standard specifications of the electronics that control the LEDs of the powerbank, is to power the LEDs only when the powerbank is being charged and not also when it delivers charge (otherwise the 2 operations could not be distinguished);

3. optionally, a third USB output port ( ) which is used to expand the charging system, for example to optionally power appliances wired through a USB cable, both small-sized such as smartphones and large-sized such as tablets. The same third port can be used to power a “double faced” version of the invention pocket, or a pocket that charges smartphones in whatever position they are placed inside it (i.e. in each one of the 4 possible positions parallel to the larger side of the pocket), transmitting from both internal surfaces of the pocket itself;
a control unit that manages the inputs taken from the battery and the mobile devices connected to the system, as well as any sensors used, optimizing the requested output. The control unit in one embodiment is integrated into the powerbank to increase the efficiency of the system, but alternatively, it can be physically separated from the battery for future products requirements, while still remaining connected to the system itself;
a pocket 2B, 2Z, 2G that integrates a wireless charging transmitter, connected to the powerbank, and a sensor that detects the opening/closing state of the pocket in order to activate or deactivate the transmitter, optimising the battery charge. When the sensor detects the telephone presence, the system sends a wake up control to the powerbank, activating the transmitter. In addition, in a ‘double faced’ option, the charging system has a second transmitter to be able to charge the smartphone inside the pocket, regardless of its positioning, i.e. with the display of the mobile phone facing the inside of the bag or outwards. The invention pocket is a pocket in which to store a smartphone without too much attention, with the huge advantage of charging it in full wireless mode. The result is that by accomplishing natural and routine gestures, such as placing one's smartphone in the pocket of the bag, one can forget about having to charge it, because this happens without any extra actions from the user and above all, without any obligation to remember to do so.

The physical characteristics of the pocket, in terms of dimensions and materials, ensure the correct alignment of the devices inside it, the exact dimensions required (height, width and thickness) having been studied, as well as the position, orientation and inclination, all without having to resort to further components or sensors.

It is contemplated that the invention pocket can be made with other types of elements and/or sensors, e.g. mechanical, electrical, electromechanical, electronic;
a wireless charging dock 3B that is the connecting link between the invention system and the external power source 4B. It is characterised by a fast charge type wireless charging transmitter, optimised for the receiver integrated into the various products, such as bags and backpacks.

In the case of bags and backpacks the invention charging dock has specific dimensions and shapes, such as to allow perfect alignment of the product above the transmitter: the four recesses 3B1, 3B2, 3B3, 3B4 allow the dock-bag (or dock-backpack) system to be centred without using external components, by only relying on the force of gravity.

This function is possible thanks to the feet B1, B2, B3, B4, designed appropriately in shape and position and integrated into the bag or backpack to slide and centre them on the charging dock.

It is contemplated that the invention charging dock is equipped with sensors and/or integrated components for additional functions or to optimise those currently in place, for example by means of magnets.

The internal connection of the components, not accessible to the user, can occur through appropriate flat or round cables (appropriately sized to meet the required electrical loads).

The connection between the invention system and mobile devices, as well as to the external power source, as highlighted above, occurs instead in full wireless mode.

The invention system is applicable to a bag-type product B, by suitably positioning the hemispherical-shaped feet B1, B2, B3, B4, centred with respect to recesses, e.g. four in number, 3B1, 3B2, 3B3, 3B4 as provided in the charging dock 3B. The invention powerbank is integrated into the bottom of the bag, inaccessible to the user, and is able to charge itself wirelessly in fast charge mode. The control unit is integrated into the powerbank, managing the integrated transmitter in the pocket, the logo and the additional USB port. The transmitter integrated in the pocket is equipped with a triple coil to allow a certain alignment tolerance of the devices inside it. It is contemplated that the pocket can integrate high-performance solutions for charge transfer, such as magnetic resonance wireless charging. The pocket is positioned inside the bag in order to facilitate locating the phone inside it, without having to pull out the objects that it contains.

The invention system is also applicable to a backpack-type product Z, through hemispherical-shaped feet, centred with respect to recesses, e.g. four, as provided in the charging dock. Also in this case, the powerbank integrates the control unit and is positioned at the bottom, inaccessible to the user. Unlike the bag, the pocket is on a shoulder strap and enables to charge a device wirelessly in fast charge mode, simply by inserting it laterally inside it. It is contemplated that the backpack can also wirelessly charge notebooks housed in a special compartment (not shown).

The invention system is also applicable to garments, for example to a jacket G, and unlike existing products, also in this case the system involves both charging the connected mobile devices and charging the same garment off an external power source, all in a natural way. In fact, it is enough to place a jacket on a ‘smart’ hanger G or valet stand V modified according to the present invention, for the system to be connected 4G, 4V to an external power source, which is transferred from the hanger or valet stand to the battery integrated in the garment, always with a gesture naturally coming to the user. In fact, leaving a jacket hanging on these smart devices that become integral parts of the system, the integrated powerbank automatically charges off the power received through a system of coils placed on one or both shoulders of the garment. The hanger or valet stand being connected to an external power source, when the user puts a jacket on it, the jacket will be charged without the user having to perform actions different from those that they would have performed anyway by placing it on a standard hanger. Components such as the hanger or the valet stand, modified in accordance with the present invention, are not standard products and have reason to exist only as components of a system according to the present invention. In the case of a jacket, the invention pocket can be sewn both on the inside and on the outside, preserving the same performance already described.

The invention system can also be integrated with fashion accessories, such as a wallet P, through the use of special components. In this case, the charging dock (smaller than the bag or backpack mentioned here above), can charge in fast charge mode a small powerbank 1P integrated into the wallet. In this case, the powerbank, in addition to including an integrated wireless receiver, can also include an integrated transmitter to be able to charge the mobile devices placed on top of the wallet. Alternatively, the transmitter, separated from the powerbank, could be placed in a different compartment for different charging modes. Also in this case, the invention system is applied in a fully wireless charge mode, and is a complete system that charges mobile devices off an external power source, but relying on routine gestures by the user. In this case, the wallet could be placed by the user on a charging dock 3P, rested on a bedside table or, alternatively, directly on a smart bedside table modified according to the present invention to integrate the wireless charging transmitter.

It is contemplated that the invention system can be integrated with a programmable high performance control unit, with the possibility of dialoguing with external devices for data (as well as power) exchange. The connection of the control unit can be wired, or wireless, for example through a bluetooth connection module.

The implementation of software, as well as of reference applications, and of additional electronic components may allow the user to have information on his product, in terms of battery state, GPS location and proximity position, push notifications, all of the above always integrated in a product that can be automatically charged, once it is placed on its related smart dock.

It is contemplated that the invention system can integrate a wireless connection also for internal components, and that it can optimise the power transfer through high performance components, such as magnetic resonance wireless charging.

The present invention has been disclosed and illustrated with reference to specific embodiments, but variations, additions or omissions may be made, without so departing from the scope of the appended claims.

1. A wireless battery charger system for mobile electronic devices, including mobile cell phones, including smartphones; smart watches; the system comprising in combination:
(i) a pocket (2B, 2Z, 2G), having two opposite sides, suitable for receiving a mobile electronic device inside it; the pocket being provided with first transmission means for direct charging of a mobile electronic device,
(ii) means constituting a battery for electrical power supply;
(iii) first wireless charging means (1B, 1Z, 1G) i.e. means constituting powerbanks for charging mobile electronic devices, such first wireless charging means comprising receiving means for their own wireless charging;
(iv) electric wired connection means between said pocket and said first wireless charging means or powerbank constituting means;
(v) control means in functional communication with said means constituting an electric power supply battery and with said first wireless charging means or powerbank constituting means;
(vi) second wireless charging means or means constituting a charging dock (3B, 3Z, 3G, 3P) for charging the system itself, which comprise second transmission means for charging said first charging means, and means for connecting to an external electric power source;
(vii) means for detecting the presence of a mobile electronic device in said pocket, in functional communication with said control means; wherein said control means impart a command to said means constituting powerbanks for activating/deactivating said transmission means for charging a mobile electronic device when the presence/absence thereof is detected in said pocket;
(viii) light emitting means in functional connection with said powerbank constituting means.

2. A battery charger system according to claim 1, wherein said control means impart a command for switching on/off said light emitting means to said powerbank constituting means when a charge phase of said powerbank constituting means is activated and when it is deactivated—respectively.

3. A battery charger system according to claim 1, wherein said powerbank constituting means further comprise electromagnetic charging energy transmission means.

4. A battery charger system according to claim 1, wherein said transmission means for charging a mobile electronic device comprise two wireless charging transmitters in opposite positions, each on one of said two opposite faces of said pocket, so that they are suitable for transmitting and thus charging from both said sides of the pocket.

5. A battery charger system according to claim 1, further equipped with means applicable to a mobile electronic device to make this chargeable wirelessly.

6. A battery charger system according to claim 1, wherein said means constituting a pocket are equipped with supports mounted inside them in a configuration suitable for forcing a correct positioning of a mobile electronic device placed inside them for the purpose of charging it.

7. A battery charger system according to claim 1, wherein said powerbank means further comprise additional wired connection means available for powering electrical appliances, including electrical appliances having larger footprints than the internal space of said pocket.

8. A battery charger system according to claim 4, wherein said powerbank means further comprise additional means of connection by wire, connected to power one of said two wireless charging transmitters in opposite positions.

9. A battery charger system according to claim 1, wherein said means constituting an electric power supply battery are integrated in said pocket.

10. A bag (B), comprising a bottom, equipped with the battery charger system according to claim 1, wherein said pocket is integrated with the bag itself; said powerbank constituting means are integrated in said bottom of the bag; said light emitting means are integrated in the bag, arranged in a position visible from the outside.

11. A bag according to claim 10, wherein said first transmission means for direct charging of a mobile electronic appliance are provided with a system of induction coils, so that they allow an alignment tolerance of an appliance in said pocket for the purpose of charging it.

12. A bag as claimed in claim 10, wherein said means constituting the charging dock and said bag comprise complementary means for centring the support of the bag on the means constituting the charging dock.

13. A bag according to claim 12, wherein said complementary centring means comprise recesses and pins integrated in said means constituting the charging dock and said bottom of the bag.

14. A bag according to claim 12, wherein said centring means comprise respective magnets.

15. A bag according to claim 10, provided with means constituting a shoulder-strap to form a backpack, wherein said pocket is integrated with said shoulder-strap.

16. A garment (G) equipped with the battery charger system according to claim 1, wherein said pocket is integrated into the garment itself; said powerbank constituting means are integrated in the garment itself; said means constituting a charging dock are integrated in a hanger; the garment being provided with a system of electromagnetic induction coils suitable for receiving electromagnetic energy from the means constituting the charging dock and transmitting it to the powerbank constituting means.

17. A garment according to claim 16 in the form of a jacket, comprising two shoulders, wherein said electromagnetic induction coils are arranged at said shoulders.

18. A wallet (P) equipped with the battery charger system according to claim 1, wherein said pocket and said powerbank constituting means are integrated in the wallet itself.

19. A wallet according to claim 18, wherein said powerbank constituting means further comprise electromagnetic charging power transmission means.

20. A bedside table integrating said second wireless charging means or means constituting a charging dock for the wireless battery charger system for mobile electronic devices according to claim 1.
